(19) United States
(12) Patent Application Publication
(10) Pub. No.: US 2003/0008798 A1
(43) Pub. Date: Jan. 9, 2003

(54) Bleaching activator granules and bleaching agent composition

(76) Inventors: Yoshinobu Imaizumi, Wakayama-shi (JP); Koichi Ohori, Wakayama-shi (JP)

Correspondence Address: BIRCH STEWART KOLASCH & BIRCH, PO BOX 747, FALLS CHURCH, VA, 22040-0747, US

(21) Appl. No.: 10/147,995

(22) Filed: May 20, 2002

(30) Foreign Application Priority Data
May 21, 2001 (JP) 2001-151305

(51) Int. Cl. D06L 1/00; C11D 3/00

(52) U.S. Cl. 510/311; 510/312; 510/376

(57) ABSTRACT

Bleaching activator granules comprising (A) an organic peracid precursor represented by the following general formula, (I):

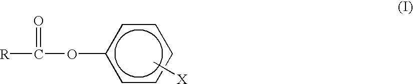

wherein R is a linear alkyl group having 7 to 15 carbon atoms, and X is a group represented by —SO₃M or —COOM, wherein M is hydrogen atom or an alkali metal atom; and (B) a magnesium salt; and a bleaching agent composition comprising the bleaching activator granules and a peroxide. The bleaching activator granules can be suitably used for all sorts of detergent system in which the calcium ions coexist.

### BACKGROUND OF THE INVENTION

1. Field of the Invention

The present invention relates to bleaching activator granules capable of effectively acting in the coexistence of calcium ions, and a bleaching agent composition comprising the granules.

2. Discussion of the Related Art

Presently, in bleaching agents and bleach detergents, sodium percarbonate or sodium perborate has been mainly utilized as a bleaching base material. However, since satisfactory bleaching performance cannot be obtained only by these base materials, organic peracid precursors such as TAED (tetraacetyl ethylenediamine) and AOBS (sodium alkanoyloxybenzenesulfonate) have been used together with the base materials. These organic peracid precursors have been known as so-called “bleaching activators” in which the organic peracid precursor reacts with hydrogen peroxide generated from a peroxide such as sodium percarbonate to give an organic peracid having strong bleaching strength, thereby giving a bleaching effect on laundry clothes.

However, there arises a problem such that when the above-mentioned organic peracid precursor is dissolved in water, the formation of the organic peracid is inhibited due to the reaction of the precursor with calcium ions in a case where calcium ions are coexistent. Among them, in an organic peracid precursor represented by the general formula (I):

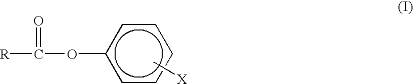

wherein R is a linear alkyl group having 7 to 15 carbon atoms, and X is a group represented by —SO₃M or —COOM, wherein M is hydrogen atom or an alkali metal ion atom,

which is an organic peracid precursor having latently high bleaching performance, the inhibition is especially remarkable. Since the organic peracid precursor becomes insoluble by the calcium ions, there arise some problems such that the final amount of the organic peracid produced is lowered, and that the bleaching performance is lowered.

As the countermeasure for the inhibition by the calcium ions described above, a process of lowering the amount of calcium ions which can react with an organic peracid precursor by using a calcium ion capturing agent such as zeolite or polymer together therewith has been generally known. However, there arise some problems in this process such that the inhibition takes place until the calcium ion capturing agent exhibits its effect, and that the inhibition also takes place especially when the calcium ion concentration is high, the calcium ions existing in an amount of equal to or greater than the amount of which the calcium ion capturing agent can capture the calcium ions.

An object of the present invention is to provide bleaching activator granules having a suppressive effect for inhibition by calcium ions, even in the existence of the calcium ions, and having excellent dissolubility; and a bleaching agent composition comprising the bleaching activator granules.

These and other objects of the present invention will be apparent from the following description.

### SUMMARY OF THE INVENTION

According to the present invention, there are provided:

[1] bleaching activator granules comprising:

(A) an organic peracid precursor represented by the following general formula (I):

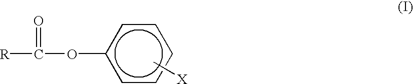

wherein R is a linear alkyl group having 7 to 15 carbon atoms, and X is a group represented by —SO₃M or —COOM, wherein M is hydrogen atom or an alkali metal atom; and

(B) a magnesium salt; and

[2] a bleaching agent composition comprising the bleaching activator granules of item [1] above and a peroxide.

### BRIEF DESCRIPTION OF THE DRAWINGS

FIG. 1 is a graph showing the amount of an organic peracid produced with the passage of time obtained in Example 1 and Comparative Example 1;

FIG. 2 is a graph showing the amount of an organic peracid produced with the passage of time obtained in Examples 2 and 3 and Comparative Examples 2 and 3; and

FIG. 3 is a graph showing the amount of an organic peracid produced with the passage of time obtained in Example 4 and Comparative Example 4.

### DETAILED DESCRIPTION OF THE INVENTION

The bleaching activator granules (hereinafter also simply referred to “granules”) of the present invention, as described above, comprise:

(A) an organic peracid precursor represented by the general formula (I):

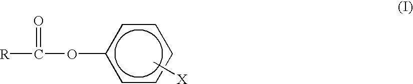

wherein R is a linear alkyl group having 7 to 15 carbon atoms, and X is a group represented by —SO₃M or —COOM, wherein M is hydrogen atom or an alkali metal atom; and

(B) a magnesium salt.

In the granules of the present invention, the component (A) is reacted with the component (B) during dissolution to form a magnesium salt of the organic peracid precursor. Since the magnesium salt of the organic peracid precursor is less likely to cause exchange with calcium ions, and the lowering of the dissolubility by the calcium ions is suppressed, there are some advantages in that a large amount of an organic peracid can be produced even in the coexistence of the calcium ions, thereby exhibiting high bleaching strength, and that the granules have excellent dissolubility.

In view of the above, as a process for suppressing the inhibition by the calcium ions, there can be thought a process of previously preparing and using a magnesium salt of the organic peracid precursor. However, since the magnesium salt of the organic peracid precursor has a lower dissolubility as compared to a hydrogenated product or an alkali metal salt, there arise some problems such that the peracid formation rate is delayed, so that much time is required until a satisfactory effect is exhibited, and that washing with a short period of time causes insoluble remnants of the granules. By contrast, since the magnesium salt of the organic peracid precursor is produced by the reaction during dissolution in the present invention, the salt exists in a dissolved state, so that there are no problem in dissolubility as described above. Further, by using the component (B) having a high water dissolubility, there are some advantages that the dispersion and/or dissolution of the granules themselves can be accelerated.

On the other hand, a process in which the component (B) is separately added in a bleaching agent composition without formulating the component (B) into the granules can be also considered. In this case, however, since the magnesium ion concentration near the component (A) during dissolution is drastically lowered, there arise some problems such that the reaction of the component (A) with the component (B) is not efficiently carried out, so that the suppressive effect of the inhibition by the calcium ions is lowered. By contrast, since the component (A) and the component (B) are formed into granules in the present invention, there are some advantages that the reaction is efficiently carried out because the component (B) is dissolved near the component (A) when the granules are dissolved.

In addition, in the present invention, as described above, there are some advantages such that the organic peracid can be efficiently produced not only in a system with no or little existence of the calcium ion capturing agent because inhibition by the calcium ions is likely to take place, but also in a system in which the calcium ion capturing agent is sufficiently added because inhibition is less likely to take place during the period until which the calcium ion capturing agent effectively acts.

1. Component (A)

The component (A) used in the present invention is not particularly limited, as long as it is an organic peracid precursor represented by the general formula (I). It is preferable that the group X takes the p-position, among the o-position, m-position and p-position, from the viewpoints of the productivity and the stability. Also, it is preferable that R has 8 to 11 carbon atoms, from the viewpoints of the bleaching performance and the stability. The alkali metal atom of M includes sodium, potassium, and the like, among which sodium is preferable. These organic peracid precursors have a particle size of preferably from 0.5 to 200 μm, more preferably from 2 to 100 μm, from the viewpoints of the granulation ability and the dissolubility. Here, the particle size can be determined in acetone by using laser diffraction-scattering type particle size distribution analyzer (“Microtrack HRA” commercially available from Nikkiso K.K.). The content of the component (A) is preferably from 10 to 95% by weight, of the granules, from the viewpoint of the bleaching performance, and more preferably the content of the component (A) is from 50 to 90% by weight, of the granules from the viewpoint of the dissolubility. These component (A)'s can be used alone or in combination of two or more kinds.

2. Component (B)

The component (B) used in the present invention is not particularly limited, as long as it is a magnesium salt. A magnesium salt having a high water-solubility is preferable, from the viewpoint of the dissolubility of the granules, among which magnesium sulfate and magnesium chloride are more preferable. Further, magnesium sulfate is especially preferable, from the viewpoints of the hygroscopicity and the granulation ability. There are some magnesium salts in a hydrate form. The hydration number is not particularly limited, and a most preferable magnesium salt can be selected from the viewpoints of the stability and the like. However, since the effects of magnesium in the present invention (suppression of the inhibition by the calcium ions) depend upon the number of the magnesium ions, those having as smaller hydration number as possible are preferable, for the purpose of reducing the amount of the magnesium salt added, and an anhydride form is especially preferable. It is preferable that the particle size of the magnesium salt is as small as possible, and that the size is even, from the viewpoints of the granulation ability and the dissolubility. Concretely, the magnesium salt granules having a size of 200 μm or less preferably constitute 90% or more of the entire magnesium salt granules, and the magnesium salt granules having a size of 100 μm or less more preferably constitute 90% or more of the entire magnesium salt granules, and the magnesium salt granules having a size of 50 μm or less especially preferably constitute 90% or more of the entire magnesium salt granules. Here, the particle size can be determined by using laser diffraction-scattering type particle size distribution analyzer (“Microtrack HRA” commercially available from Nikkiso K.K.).

The content of the component (B) in the granules is such that a molar ratio of the component (B) to the component (A), i.e. B/A, is preferably from 0.05 to 1.5, more preferably from 0.1 to 1, especially preferably from 0.2 to 0.8, from the viewpoints of the reactivity and the reaction rate. The molar ratio is preferably 0.05 or more, from the viewpoint of obtaining a satisfactory suppressive effect of the inhibition by the calcium ions, and the molar ratio is preferably 1.5 or less, from the viewpoints of economic advantages and the like.

The granules of the present invention can be prepared by using a binder substance together in addition to the above-mentioned components (A) and (B). The binder substance is not particularly limited, as long as the granules have an ability of binding the constituting components. Water and/or a water-soluble binder is preferable, from the viewpoint of the dissolubility of the granules, and a water-soluble binder capable of being solidified at a temperature of 40° C. or lower and having binding ability thereat is especially preferable, from the viewpoint of the storage stability. As the water-soluble binder, a polyethylene glycol having an average molecular weight of from 2000 to 30000, a saturated or unsaturated fatty acid having 8 to 18 carbon atoms, a dibasic acid such as succinic acid or glutaric acid or the like can be used, and the polyethylene glycol is especially preferable. In addition, a substance having as smaller magnesium ion capturing ability as possible is preferable, from the viewpoint of sufficiently exhibiting the effects of the component (B), and the polyethylene glycol and a sodium linear alkylbenzenesulfonate are especially preferable. These binder substances can be used alone or in admixture of two or more kinds. It is preferable that the binder substance is used in an amount of from 0.05 to 4 times by weight, especially preferably from 0.07 to 3 times by weight that of a total amount of the above-mentioned component (A) and component (B). In addition, a surfactant can also serve as a binder.

3. Other Components

The granules of the present invention may contain other components, in addition to the component (A), the component (B) and the binder substance mentioned above, as occasion demands. Listed below are one example thereof.

(1) Surfactant

It is preferable to add a surfactant for the purposes of improving the dissolubility and accelerating the formation of the organic peracid by the reaction of the formed magnesium salt of the organic peracid precursor with a peroxide mentioned below. The surfactant includes nonionic surfactants such as ethylene oxide adduct and/or propylene oxide adduct of an alcohol or fatty acid having an alkyl group moiety having 8 to 18 carbon atoms; anionic surfactants such as alkylbenzenesulfonates, alkylsulfates, and α-olefinsulfonates; and the like. The content of the surfactant is preferably from 0.1 to 30% by weight, more preferably from 1 to 20% by weight, of the granules of the present invention.

(2) Solid or Powdery Acid

A solid or powdery acid may be added as a stabilizing agent for the component (A). The solid or powdery acid includes, for instance, formic acid, succinic acid, fumaric acid, citric acid, phosphoric acid, zeolite showing acidity in a solid state, and the like, among which succinic acid and citric acid are preferable. These acids may form a salt, and the counter ions are alkali metal ions, ammonium ions, and the like. The content of the solid or powdery acid is preferably from 0.5 to 10% by weight, more preferably from 1 to 5% by weight, of the granules of the present invention.

(3) Anti-Redeposition Agents

There can be added an anti-redeposition agent such as polyethylene glycol, polyvinyl alcohol, polyvinyl pyrrolidone or carboxymethyl cellulose as occasion demands.

(4) Dissolution Accelerator

There can be added a dissolution accelerator such as urea, a urea derivative, thiourea, a paratoluenesulfonate and a water-soluble inorganic salt as occasion demands.

(5) Excipient

There can be added an inorganic salt such as sodium sulfate or zeolite as an excipient for the purposes of improving granulation ability and the like during granulation.

(6) Colorant

There may be added a pigment, a dye or the like as a colorant, from the viewpoints of improving external appearance and the like.

(7) Coating Agent

A surface coating can be carried out for the purposes of improving the particle strength, the storage stability, and the like.

4. Process for Preparing Granules

The granules of the present invention can be prepared by, for instance, agitation-tumbling granulation process, extrusion granulation process, spraying and cooling process, and the like, without being particularly limited thereto. In the case where the granules are prepared by the agitation-tumbling granulation process, the process for preparing the granules includes, for instance, a process comprising mixing a component (A), a component (B), a binder substance and other components, raising the temperature of the mixture to dissolve the binder substance, granulating the mixture, and cooling the granules; a process comprising adding a melted binder substance with agitating and mixing a component (A), a component (B) and other components, and granulating the mixture; a process comprising adding an aqueous binder solution with agitating and mixing a component (A), a component (B) and other components, granulating the mixture, and drying the granules; and the like. In the case where the granules are prepared by the extrusion granulation process, the process for preparing the granules includes, for instance, a process comprising melting and mixing a component (A), a component (B), a binder substance and other components, and granulating the mixture by extruding the mixture through an extrusion-granulator; a process comprising melting and mixing a component (A), a component (B), an aqueous binder solution and other components, granulating the mixture by extruding the mixture through an extrusion-granulator, and drying the granules; and the like. In the case where the granules are prepared by the spraying and cooling process, the process for preparing the granules includes, for instance, a process comprising melting and mixing a component (A), a component (B), a binder substance and other components, and spraying the mixture from a nozzle to a space kept at a low temperature to give granules; and the like.

Here, it is preferable to control the water content in the component (A) during granulation because the degradation of the component (A) is accelerated by the water content, and it is especially preferable to granulate under as much anhydrous conditions as possible. In such a case, it is preferable to use a thermoplastic, water-soluble binder capable of being solidified at a temperature of 40° C. or lower and having binding ability thereat as a binder. In addition, in a case where water and an aqueous binder solution is used as a binder, it is preferable to sufficiently dry the granules in the subsequent steps.

The devices usable in the granulation include, for instance, High-Speed Mixer commercially available from Fukae Powtec Kogyo Corp., PLOUGH SHARE Mixer (commercially available from PACIFIC MACHINERY & ENGINEERING Co., LTD.), and the like for the agitation-tumbling granulation process; Pelleter Double, Twin Dome Gran commercially available from Fuji Paudal Co., Ltd., and the like for the extrusion granulation process; a spray-cooling tower or the like for the spraying and cooling process.

The granules obtained by these preparation processes may be subjected to particle size adjustments by disintegration, sphering or the like as occasion demands, for the purposes of improving the external appearance and the yield after the granulation. The devices used for the disintegration include power-mill commercially available from K.K. Dalton, a flash mill commercially available from Fuji Paudal Co., Ltd., Fitz mill commercially available from Fitzpatrick (U.S.A.), Co-mill commercially available from Quadro (Canada), Speed Mill commercially available from Okada Seiko K.K., and the like. The sphering device includes a marumelizer commercially available from Fuji Paudal Co., Ltd., and the like. In addition, especially when a thermoplastic binder is used, the temperature at which the binder is fed to the disintegrator needs to be equal to or lower than the melting point of the binder, and it is preferable that the temperature is usually cooled to near room temperature. For instance, when the granules are fed to a vibrating cooler and disintegrated after cooling the granules to a given temperature, there is an advantage that the deposition of the disintegrated product within the disintegrator is suppressed.

The granules subjected to size adjustment may be adjusted to a given granule size by classification, for the purpose of reducing fine power and/or coarse granules. By classifying and adjusting the particle size, the external appearance upon use can be improved. The fine powder and/or the coarse granules removed by classification can be, for instance, pulverized to be used as granulation raw materials, or melted again to be used as raw materials, whereby the yield can be improved.

These granules can be subjected to surface coating for the purposes of improving the particle strength, the storage stability, and the like. The surface coating may be carried out after any of granulation, size adjustment, or classification steps. Concretely, a surface coat formed by a melted binder using the agitation-tumbling granulator, a spray-coating using a fluidized dryer, and the like can be used. In addition, the coat after the size adjustment step is preferable, from the viewpoint of evenness of the coat, and the coat after the classification step is preferable from the viewpoint of re-cycling.

5. Quality of Granules

The particle size of the granules of the present invention is not particularly restricted. The average particle size of the granules is preferably from 100 to 5000 μm, more preferably from 200 to 2000 μm, from the viewpoints of the external appearance and the dissolubility. The granular shape is most preferably spherical, from the viewpoints of the external appearance and classification ability, and it is preferable that a ratio of an extrusion diameter to a length is nearly 1 for those extrusion granules without sphering treatment. In addition, it is preferable that the granules are as evenly sized as possible in the particle size distribution, from the viewpoint of the external appearance. On the other hand, the water content in a final product is preferably 10% by weight or less, more preferably 5% by weight or less, especially preferably 1% by weight or less, from the viewpoint of the storage stability. 6. Bleaching Agent Composition

The bleaching agent composition of the present invention comprises the above-mentioned bleaching activator granules and a peroxide. The content of the bleaching activator granules is preferably from 0.1 to 20% by weight, more preferably from 0.5 to 10% by weight, of the bleaching agent composition.

As the peroxide used in the present invention, an oxygen-based peroxide is preferably used. The oxygen-based peroxide includes hydrogen peroxide, an inorganic peroxide such as sodium percarbonate, sodium perborate, sodium sulfate-sodium chloride-hydrogen peroxide adduct, potassium monopersulfate, and the like. It is preferable that the content of the peroxide is from 1 to 90% by weight of the bleaching agent composition.

In addition, the bleaching agent composition may contain other optional components, for instance, an enzyme, an inorganic salt such as sodium carbonate, a surfactant, and a fluorescer, and the like as occasion demands, and it is especially preferable to use the bleaching agent composition as a surfactant-containing bleaching detergent composition. Concrete examples of these optional components are given hereinbelow.

(1) Surfactant

In the bleaching agent composition of the present invention, there can be formulated a surfactant such as an anionic surfactant or a nonionic surfactant.

The anionic surfactants are exemplified by alkylbenzenesulfonates; alkyl ether or alkenyl ether sulfates; salts of alkyl or alkenyl sulfuric acid esters; á-olefinsulfonates; alkanesulfonates; salts of saturated or unsaturated fatty acids; N-acyl amino acid-type surfactants; alkyl ether or alkenyl ether carboxylates, amino acid-type surfactants; alkyl or alkenyl phosphoric acid esters or salts thereof, and the like.

In addition, the nonionic surfactants include, for instance, polyoxyalkylene alkyl (or alkenyl) ethers, polyoxyethylene alkylphenyl ethers, higher fatty acid alkanolamides or alkylene oxide adducts thereof, sucrose fatty acid esters, alkyl glycosides, glycerol fatty acid monoesters, and the like. Among them, the nonionic surfactants of the following items (1) to (3) are especially preferable.

(1) a polyoxyethylene alkyl ether of which alcohol moiety has 10 to 20 carbon atoms in average, and 1 to 30 moles of ethylene oxide;

(2) a polyoxyethylene alkylphenyl ether of which alcohol moiety has 9 to 12 carbon atoms in average, and 1 to 25 moles of ethylene oxide; and

(3) an alkyl glycoside represented by the following general formula (II):

R′(OC₂H₄)ₚG_{q} (II)

wherein R′ is an alkyl group having 9 to 14 carbon atoms; p is an integer of from 0 to 2; G is glucose residue, fructose residue, maltose residue or sucrose residue; q is a number of from 1 to 4, preferably 1, 2 or 3.

It is preferable that the content of the above-mentioned anionic surfactant and nonionic surfactant is 1 to 60% by weight of the bleaching agent composition.

In the bleaching agent composition of the present invention, there may be properly formulated other surfactants such as betain-type amphoteric surfactants, sulfonate-type amphoteric surfactants, phosphoric acid ester-based surfactants, and cationic surfactants.

(2) Builder

In the bleaching agent composition of the present invention, there may be formulated a builder which can be generally formulated in a detergent or bleaching agent. The builder includes, for instance, those listed under the following items [1] to [6]. The content of the builder is preferably from 10 to 90% by weight, more preferably from 20 to 70% by weight, of the bleaching agent composition.

[1] Divalent Metal Ion Capturing Agent

(1) salts of phosphoric acids such as orthophosphate, pyrophosphate, tripolyphosphate, metaphosphate, hexametaphosphate and salts of phytic acid;

(2) salts of phosphonic acids such as ethane-1,1-diphosphonate, ethane-1,1,2-triphosphonate, ethane-1-hydroxy-1,1-diphosphonate and derivatives thereof, ethanehydroxy-1,1,2-triphosphonate, ethane-1,2-dicarboxy-1,2-diphosphonate and methanehydroxyphosphonate;

(3) salts of phosphonocarboxylic acids such as 2-phosphonobutane-1,2-dicarboxylic acid, 1-phosphonobutane-2,3,4-tricarboxylic acid, and α-methylphosphonosuccinic acid;

(4) salts of amino acids such as aspartic acid, glutamic acid and glycine;

(5) aminopolyacetates such as nitrilotriacetate, iminodiacetate, ethylenediaminetetraacetate, diethylenetriamilnepentaacetate, glycol ether diaminetetraacetate, hydroxyethyl iminodiacetate, triethylenetetraminehexaacetate, and djenkolate;

(6) polymeric electrolytes such as polyacrylic acid, acrylic acid-maleic acid copolymers, poly(fumaric acid), poly(maleic acid), poly-α-hydroxyacrylic acid, and polyacetal carboxylic acids or salts thereof; and

(7) organic salts of carboxylic acids such as diglycolic acid, oxydisuccinic acid, carboxymethyl oxysuccinic acid, citric acid, lactic acid, tartaric acid, oxalic acid, malic acid, gluconic acid, carboxymethyl tartaric acid and carboxymethyl succinic acid.

The salts listed in the above-mentioned items (1) to (7) include alkali metal salts, alkaline earth metal salts, aluminum salts, ammonium salts, and the like.

[2] Alkalizing Agent or Inorganic Electrolyte

silicates, carbonates, sulfates, and the like, wherein the salts are preferably alkali metal salts.

[3] Anti-Redeposition Agent

polyethylene glycol, polyvinyl alcohol, polyvinyl pyrrolidone, carboxymethyl cellulose, and the like.

[4] Enzyme

protease, lipase, amylase, cellulase, and the like. Especially it is preferable that the content of the protease is from 0.1 to 5% by weight of the bleaching agent composition.

[5] Stabilizer for Peroxide

magnesium salts such as magnesium sulfate, magnesium silicate, magnesium chloride, magnesium silicofluoride, magnesium oxide and magnesium hydroxide; boric acid and salts thereof; and the like.

[6] Perfume, Fluorescer, and Coloring Matter

The bleaching agent composition of the present invention can be prepared by properly mixing the above-mentioned bleaching activator granules and peroxide, and further the above-mentioned various components by a known process as occasion demands.

Since the bleaching agent composition of the present invention having the constitution exhibits excellent effects of suppressing the inhibition by the calcium ions and producing an organic peracid in a large amount, the bleaching agent composition can be suitably used in all sorts of deterging compositions in which calcium ions coexist.

### EXAMPLES

### Example 1

A mixer (Nauta Mixer Model NX-S commercially available from Hosokawa Micron Corporation) was charged with 8.84 kg of the organic peracid precursor represented by the formula (III):

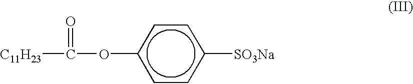

0.39 kg of succinic acid (20 mesh-pass product, commercially available from Kawasaki Kasei Kogyo K.K.), 2.21 kg of polyethylene glycol (K-PEG 6000 commercially available from Kao Corporation), 0.52 kg of ethoxylated propoxylated alcohol (EMULGEN KS-108 commercially available from Kao Corporation), and 1.04 kg of magnesium sulfate (commercially available from Wako Pure Chemical Industries, Ltd., ratio of those having a particle size of 50 μm or less after pulverization being 100%). The mixture was mixed and heated at a jacket temperature of 80° C., a rotational speed 121 rpm, a revolution rotational speed of 5.5 rpm, and the mixture was taken out of the mixer when the powder temperature reached 75° C. Next, the resulting mixture was extruded through a screen having a pore diameter of 700 μm by an extrusion granulator (“Pelleter Double EXD-60,” commercially available from Fuji Paudal Co., Ltd.), and the mixture was densified. The resulting extruded product was cooled, and thereafter disintegrated with a particle size adjusting device (“Flash Mill FL200” commercially available from Fuji Paudal Co., Ltd.), and classified to adjust the particle size to 350 to 1410 μm, to give bleaching activator granules (water content: 0.2% by weight, magnesium sulfate/organic peracid precursor (molar ratio): 0.37).

### Example 2

A horizontal agitation-tumbling granulator (“PLOUGH SHARE Mixer WB-20” commercially available from PACIFIC MACHINERY & ENGINEERING Co., LTD.) was charged with 4.0 kg of the same organic peracid precursor as in Example 1, 0.2 kg of ethoxylated propoxylated alcohol (EMULGEN KS-108, commercially available from Kao Corporation), and 0.5 kg of magnesium sulfate (commercially available from Wako Pure Chemical Industries, Ltd., ratio of those having a particle size of 100 μm or less being 96%). With agitating and tumbling the granulator at a rotational speed of a main shaft of 100 rpm and a rotational speed of a chopper of 3600 rpm, 1.5 kg of an aqueous solution of a sodium alkylbenzenesulfonate (commercially available from Kao Corporation) (solid content concentration: 20% by weight) was added to the mixture. After the termination of the addition, the mixture was dried at 80° C. for 2 hours, and the dried product was subjected to a particle size adjustment to a size of 125 to 710 μm by means of classification, to give bleaching activator granules (water content: 1.2% by weight, magnesium sulfate/organic peracid precursor (molar ratio): 0.39).

### Example 3

The procedures were carried out under the same conditions as in Example 2 except that 1 kg of an aqueous solution of sodium polyacrylate (commercially available from Kao Corporation, completely neutralized product, molecular weight: 10000) (solid content concentration: 30% by weight) was used in place of the sodium alkylbenzenesulfonate, to give bleaching activator granules (water content: 1.2% by weight, magnesium sulfate/organic peracid precursor (molar ratio): 0.39).

### Comparative Example 1

The procedures were carried out under the same conditions as in Example 1, except that sodium sulfate (commercially available from Shikoku Kasei K.K.; ratio of those having a particle size of 50 μm or less after pulverization being 100%), to give granules.

### Comparative Example 2

The procedures were carried out under the same conditions as in Example 2, except that sodium sulfate (commercially available from Shikoku Kasei K.K.; ratio of those having a particle size of 50 μm or less after pulverization being 100%), to give granules.

### Test Example

In 1 liter of water having a calcium ion concentration of 0.000476 mol/L (one-liter beaker used) were completely dissolved 66.7 mg of Na₂CO₃ and 66.7 mg of 2Na₂CO₃.3H₂O₂. Thereafter, the granules obtained in Examples and Comparative Examples were added thereto, and the mixture was mixed with stirring with a magnetic stirrer at 20° C. (stirrer piece having a length of 30 mm, a diameter of 5 mm and rotated at 350 r.p.m.). Subsequently, an amount of effective oxygen from percarbonic acid was titrated by utilizing iodometric titration flow method, the amount of an organic peracid produced was determined with the passage of time up till 20 minutes. The amount of the granules in each of Examples and Comparative Examples is as shown in Table 1.

TABLE 1

| Bleaching Activator Granules | Amount (mg) |
|---|---|
| Example 1, Comparative Example 1 | 39.3 |
| Examples 2, 3, Comparative Example 2 | 33.4 |

### Comparative Example 3

In 1 liter of water having a calcium ion concentration of 0.000476 mol/L (one-liter beaker used) were completely dissolved 66.7 mg of Na₂CO₃, 66.7 mg of 2Na₂CO₃.3H₂O₂, and 3.3 mg of magnesium sulfate. Thereafter, 33.4 mg of the granules obtained in Comparative Example 2 were added thereto. The amount of an organic peracid produced was determined with the passage of time up till 20 minutes in the same manner as in Examples 1 to 3 and Comparative Examples 1 and 2.

### Example 4

The procedures were carried out under the same conditions as in Example 1 except that there were used as raw materials 8.84 kg of the organic peracid precursor of Example 1, 0.39 kg of succinic acid (the same one as in Example 1), 2.21 kg of polyethylene glycol (the same one as in Example 1), 0.52 kg of ethoxylated propoxylated alcohol (“EMULGEN KS-108,” the same one as in Example 1), 0.52 kg of magnesium sulfate (the same one as in Example 1), and 0.52 kg of sodium lauryl sulfate (“EMAL 10” powder, commercially available from Kao Corporation), to give granules (water content: 0.2% by weight, magnesium sulfate/organic peracid precursor (molar ratio): 0.18).

### Comparative Example 4

The procedures were carried out under the same conditions as in Example 4, except that sodium sulfate (commercially available from Shikoku Kasei K.K.; ratio of those having a particle size of 50 μm or less after pulverization being 100%) was used in place of magnesium sulfate.

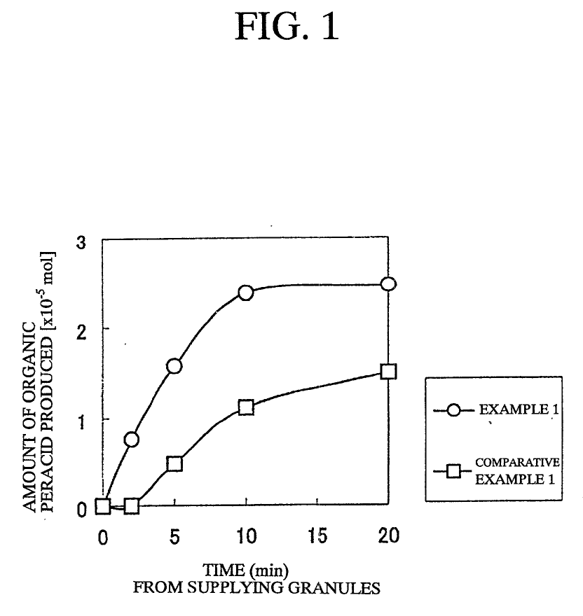

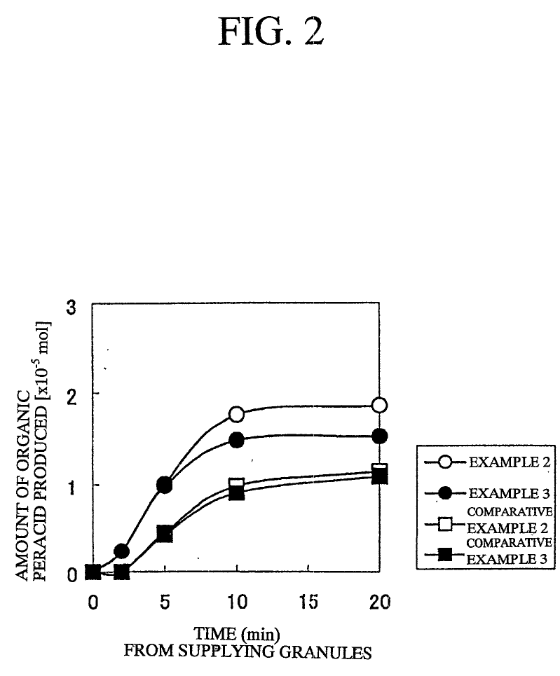

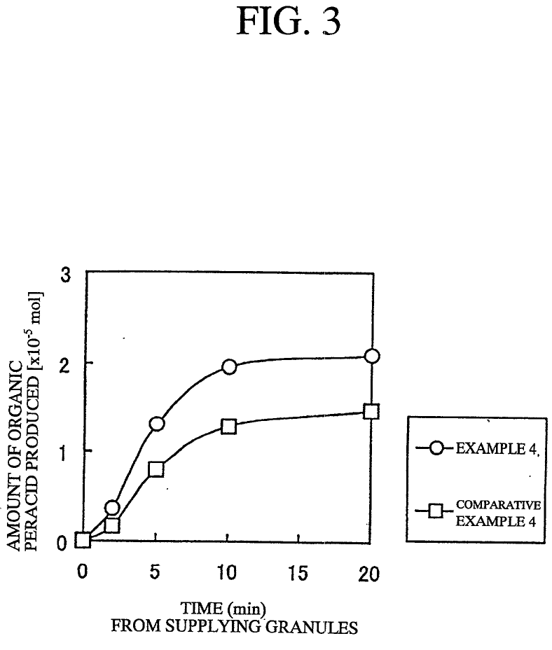

The amounts of the organic peracid produced with the passage of time obtained in Example 1 and Comparative Example 1 are shown in FIG. 1; the amounts of the organic peracid produced with the passage of time obtained in Examples 2 and 3 and Comparative Examples 2 and 3 are shown in FIG. 2; and the amounts of the organic peracid produced with the passage of time obtained in Example 4 and Comparative Example 4 are shown in FIG. 3.

As is seen from these results, since the granules obtained in Examples 1 to 4 all showed larger amounts of organic peracid produced even in the coexistence of calcium ions, as compared to the granules obtained in Comparative Examples 1 to 4, the granules obtained in Examples 1 to 4 suppress inhibition by calcium ions, and have excellent dissolubility.

Since the bleaching activator granules of the present invention suppress inhibition by calcium ions and have excellent dissolubility, there are exhibited some excellent effects that the bleaching activator granules can have high detergency in the coexistence of the calcium ions, so that the granules can be suitably used for all sorts of detergent system in which the calcium ions coexist.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. Bleaching activator granules comprising:
(A) an organic peracid precursor represented by the following general formula (I): 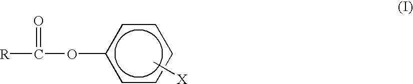
wherein R is a linear alkyl group having 7 to 15 carbon atoms, and X is a group represented by —SO₃M or —COOM, wherein M is hydrogen atom or an alkali metal atom; and
(B) a magnesium salt.

2. The bleaching activator granules according to claim 1, wherein the component (B) comprises magnesium salt particles having a size of 200 μm or less in an amount of 90% or more of entire magnesium salt particles.

3. The bleaching activator granules according to claim 1 or 2, wherein the component (B) is magnesium chloride and/or magnesium sulfate.

4. The bleaching activator granules according to any one of claims 1 to 3, wherein a molar ratio of the component (B) contained in the bleaching activator granules to the component (A) is from 0.05 to 1.5.

5. A bleaching agent composition comprising the bleaching activator granules of any one of claims 1 to 4 and a peroxide.
